(19) United States
(12) Patent Application Publication
(10) Pub. No.: US 2026/0189515 A1
(43) Pub. Date: Jul. 2, 2026

(54) PEER-TO-PEER RESOURCE POOLING PROTOCOL

(71) Applicant: Wells Fargo Bank, N.A., San Francisco, CA (US)

(72) Inventors: Alan W. Hecht, San Francisco, CA (US); Dennis E. Montenegro, Concord, CA (US); Sadie S. Salim, Mill Valley, CA (US); Benjamin S. Taylor, Williston, VT (US); Sruthi R. Vangala, San Francisco, CA (US)

(21) Appl. No.: 19/008,289

(22) Filed: Jan. 2, 2025

(51) Int. Cl. H04L 47/762; H04L 47/783; H04L 67/52

(52) U.S. Cl. CPC H04L 47/762; H04L 47/783; H04L 67/52

(57) ABSTRACT

A method may include accessing a database of shared resource data structures, a shared resource data structure in the database of shared resource data structures including: shared resource identifier; a plurality of user identifiers; and a plurality of network-enabled computing device identifiers; receiving, using a processing unit, a data value from a network-enabled computing device; matching the network-enabled computing device to the shared resource data structure in the database based on an identifier of the network-enabled computing device; selecting, using the processing unit, a user identifier of the plurality of user identifiers; and modifying an apportionment value in the shared resource data structure associated with the user identifier based on the data value.

### BACKGROUND

A web server may serve web applications that include user interfaces presented on web clients. The web server may generate a user interface that allows a user to create a user profile. The user profile may include user credentials used to log in to the web server. The web server may include interfaces to receive identification of other users. In this manner, a group of users may be connected and communicate with each other.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is an illustration of components of a client device and an application server, according to various examples.

FIG. 2 is a block diagram of a data structure, according to various examples

FIG. 3 is a flowchart illustrating a method to modify a data structure based on a received data value.

FIG. 4 is a block diagram illustrating a machine in the example form of computer system within which a set or sequence of instructions may be executed to cause the machine to perform any one of the methodologies discussed herein, according to various examples.

### DETAILED DESCRIPTION

People will often group (or be grouped) together for a common purpose related to a shared resource, such as purchasing a boat, going on a vacation, or managing common property as part of a homeowner's association. There are several problems with existing computing systems that attempt to help the group of people track and manage expenses and use of the shared resources. The problems are not merely related to record keeping. In many instances, the systems suffer from a lack of knowledge of data that may assist in the management of the shared resource.

For example, consider the situation in which a group of friends purchase a boat together and want to keep track of the usage of the boat in a holistic and fair manner. Existing systems may use a static system in which each person indicates a percentage of the time they plan on using the boat during the year. Then, the total costs of the boat may be split according to the percentage. However, these systems rely on the users self-reporting and, therefore, may not reflect actual usage of the boat or unexpected expenses that may accrue.

Technical challenges arise from integrating various data sources and devices to provide a comprehensive view of the shared resource. For instance, incorporating data from sensors, smart devices, and financial transactions uses robust data processing and real-time analytics capabilities. Additionally, ensuring data accuracy and security while maintaining user privacy adds another layer of complexity. Existing systems often lack the ability to dynamically adjust values based on real-time data, leading to potential disputes and inequities among users.

In view of the technical limitations of existing solutions, described herein are systems and methods for using network-enabled computing devices that provide real-time data to a server that tracks the usage of a shared resource related to a group of users. Additionally, the server may use machine learning models to provide more accurate estimates of expected expenses associated with the shared resource. Furthermore, specifically configured user interfaces may be generated to allow the users to set preferences and view the real-time usage data.

The following description outlines specific examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” can mean (A); (B); (C): (A and B); (B and C); or (A, B, and C). Furthermore, using such phrases does not negate the possibility of other options (e.g., (D)).

Throughout this disclosure, components may perform electronic actions responding to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

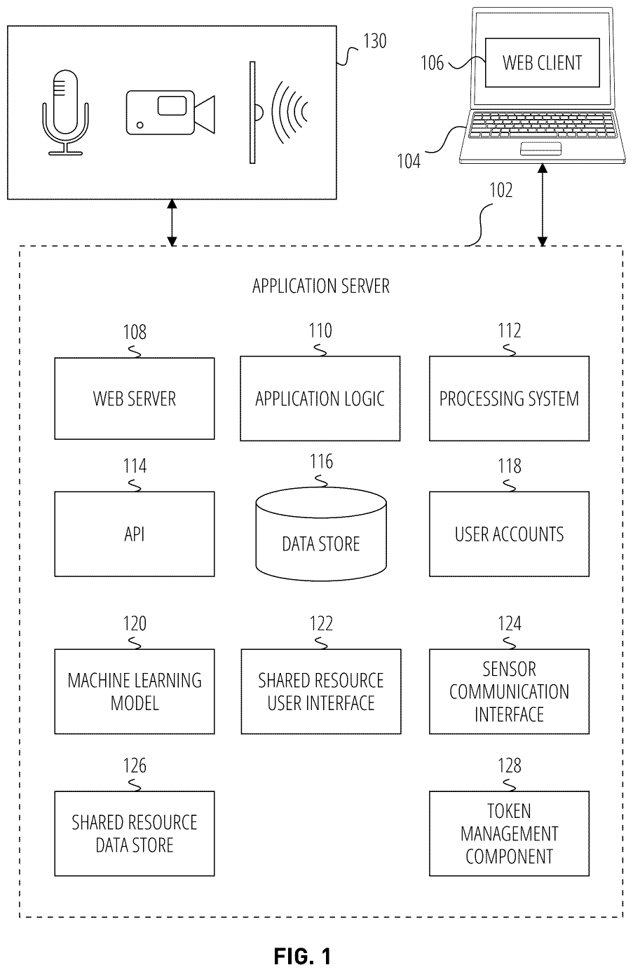

FIG. 1 illustrates the components of a client device and an application server according to various examples. The client device 104 may interact with application server 102 to create and manage shared resources between users. For example, a shared resource may be a physical asset such as a rental property, a boat, common areas of a neighborhood, etc. A shared resource may also be for an intangible purpose, such as an event (e.g., vacation). Users may use the application server 102 via a client device 104 to create and edit shared resource data structures (stored in shared resource data store 126) via shared resource user interface 122, as described in more detail below.

Application server 102 is illustrated as separate elements (e.g., components). However, the functionality of multiple individual elements may be performed by a single element. An element may represent computer program code executable by processing system 112. The program code may be stored on a storage device (e.g., data store 116) and loaded into the memory of the processing system 112 for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®).

Client device 104 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., specially configured user interfaces). In some embodiments, computing devices may comprise one or more of a touch screen, camera, keyboard, microphone, or Global Positioning System (GPS) device.

Client device 104 and application server 102 may communicate via a network (not shown). The network may include local-area networks (LAN), wide-area networks (WAN), wireless networks (e.g., 802.11 or cellular network), Public Switched Telephone Network (PSTN), ad hoc networks, cellular, personal area networks or peer-to-peer (e.g., Bluetooth®, Wi-Fi Direct), or other combinations or permutations of network protocols and network types. The network may include a single Local Area Network (LAN), Wide-Area Network (WAN), or combinations of LANs or WANs, such as the Internet.

The network-enabled computing devices 130 may also communicate with the application server 102. Network-enabled computing devices 130 may facilitate real-time data collection and interaction with the shared resource. These devices encompass a variety of sensors and smart devices that provide data points for managing and monitoring shared resources. Network-enabled computing devices 130 may include, but are not limited to, proximity sensors, motion sensors, optical sensors, microphones, smart locks, smart appliances (e.g., refrigerators, ovens), and point-of-sale systems.

Proximity sensors within the network-enabled computing devices 130 may detect the presence of users or objects in a defined area. The sensors may be placed to monitor access to shared resources, such as a boat or a rental property. For example, a proximity sensor may be used as a door sensor such that a door is considered closed when the proximity sensor has a range of less than 3 mm (or other configurable value). When a proximity sensor detects a change, it may transmit a data value (e.g., the current or change in proximity value) to the application server 102. The data value may be transmitted via API 114 and include an identifier of the network-enabled computing device.

Motion sensors may detect and capture movement. Motion sensors may be used in shared spaces, such as common areas in a homeowner's association or shared rooms in a vacation rental. The data collected by motion sensors is transmitted to the application server 102, where it may be analyzed to determine the extent of each user's interaction with the shared resource. For example, if the location of a user's mobile phone may be correlated within a certain distance to the motion sensor, it may be assumed the motion was for the user.

Optical sensors, including cameras, may provide visual data that can be used for various purposes, such as security monitoring and usage verification. For instance, an optical sensor installed on a shared boat may capture images or videos of users, which can then be processed using facial recognition models to identify individuals.

Network-enabled computing devices may further include smart devices such as locks and refrigerators. Smart locks may control and monitor access to shared resources. The data from smart locks may be transmitted to the application server 102, which updates the shared resource data structure to reflect access events. Similarly, smart refrigerators can track the usage of stored items, providing data on consumption patterns. This information may be used to adjust the apportionment values in the shared resource data structure,

Point-of-sale systems may be used to track expenses incurred by users, such as fuel purchases for a shared boat or groceries for a shared vacation home. The data from point-of-sale systems is transmitted to the application server 102, where the application server 102 may use the data to update the shared resource data structure. This ensures that expenses are accurately recorded and apportioned among the users based on their contributions and usage.

Each network-enabled computing device 130 may identified by a device identifier, a device type, and a location. The device identifier identifies each device used with application server 102. The device type categorizes the kind of device, such as a sensor, camera, or smart device, providing context for the data collected. The location specifies the geographical position or context of the device. The device identifier, device type, and location may be stored in a data structure as part of data store 116.

In some examples, the communication between network-enabled computing devices 130, application server 102, and client device 104 may occur using an application programming interface (API) such as API 114. An API provides a method for computing processes to exchange data. A web-based API (e.g., API 114) may permit communications between two or more computing devices, such as a client and a server. The API may define a set of HTTP calls according to Representational State Transfer (RESTful) practices. A RESTful API may define various GET, PUT, POST, and DELETE methods to create, replace, update, and delete data stored in a database (e.g., data store 116). For example, a network-enabled computing device may transmit a data value (e.g., sensor reading) using the API 114.

APIs may also be defined in frameworks provided by an operating system (OS) to access data in an application that an application may not regularly be permitted to access. For example, the OS may define an API call to obtain the current location of a computing device on which the OS is installed.

The sensor communication interface 124 may communicate with network-enabled computing devices 130. The sensor communication interface 124 may work with the API 114 to receive and request data from these devices. The network-enabled computing devices 130 may use various communication methods. For example, some devices have built-in cellular connections to send data directly to the application server 102. Others may relay their information through third-party services that manage devices that do not have internet access. Therefore, the sensor communication interface 124 may communicate with the third-party service.

The API 114 may define a set of HTTP calls (e.g., GET, POST) to facilitate data exchange between the devices and the application server 102. For example, a network-enabled computing device may transmit a sensor reading using a POST method. The sensor communication interface 124 may receive this data, process it, and update the resource data structures associated with an identifier of the network-enabled computing device that transmitted the sensor reading.

The sensor communication interface 124 may also request data from the network-enabled computing devices 130. For instance, the sensor communication interface 124 may transmit a GET request to a smart lock (or a third-party server) to verify its status. The smart lock responds with the requested data, which the sensor communication interface 124 processes and integrates into the shared resource data structure.

Application server 102 may include web server 108 to enable data exchanges with client device 104 via web client 106. Although generally discussed in the context of delivering webpages via the Hypertext Transfer Protocol (HTTP), other network protocols may be utilized by web server 108 (e.g., File Transfer Protocol, Telnet, Secure Shell, etc.). A user may enter a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 108. In response, web server 108 may transmit a web page rendered on a client device's display device (e.g., a mobile phone, desktop computer, etc.).

Additionally, web server 108 may enable users to interact with one or more web applications provided in a transmitted web page. A web application may provide user interface (UI) components rendered on a display device of the client device 104. The user may interact (e.g., select, move, enter text into) with the UI components, and, based on the interaction, the web application may update one or more portions of the web page. A web application may be executed in whole or in part locally on client device 104. The web application may populate the UI components with data from external or internal sources (e.g., data store 116) in various examples.

In various examples, the web application is a dynamic user interface with a shared resource user interface 122. In various examples, a shared resource may be encoded as a shared resource data structure and stored in shared resource data store 126. The shared resource user interface 122 may present and configure elements associated with the shared resource data structures stored in the shared resource data store 126. The shared resource user interface 122 enables users to create, edit, and view the status and values of shared resources.

The shared resource user interface 122 may present various input elements to the users, allowing them to enter data related to the shared resource. For example, users may input the type of shared resource, its purpose, and the user identifiers of the participants involved. The interface may also include options for setting preferences, such as spending limits, time restrictions, and voting thresholds for decision-making processes.

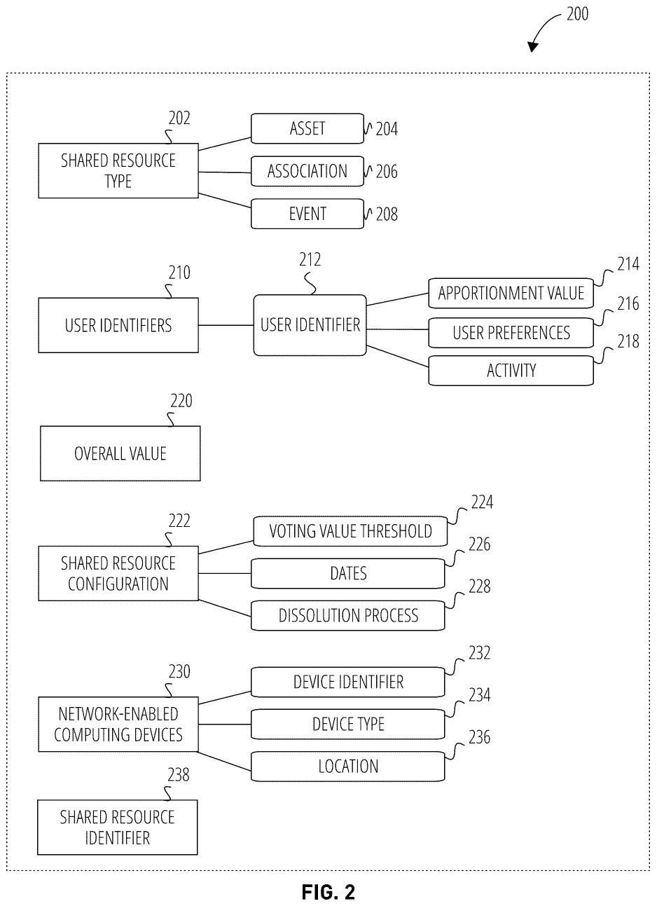

The shared resource user interface 122 may be generated and presented on the display device of the client device 104. For example, an interface may include multiple sections or tabs. For instance, one section may display the current status of the shared resource, including the overall value and individual apportionment values (discussed further in FIG. 2) for each user.

One or more machine learning models (e.g., machine learning model 120) may be used to assist users in creating the shared resource data structure. For example, the shared resource user interface 122 may include an input box configured to receive text from a user detailing the purpose of the shared resource. The entered data may be submitted to a generative artificial intelligence (GenAI) model. The GenAI model may generate a response tailored to the shared resource type and purpose.

For example, a prompt template may be stored that accompanies the entered data. Different prompt templates may be used depending on the type of shared resource. For example, for an asset, the prompt template may request that the GenAI output expected operational costs related to the shared resource. A prompt may be, “Please provide estimated operations costs for the following description. Also, provide a split of costs given the number of people sharing the resource.” For a vacation, the prompt template may request expected costs for lodging and entertainment. The prompt template may also request that the response be in a table format.

The output of the GenAI may be presented on the shared resource user interface 122. In various examples, the output is parsed by another machine learning model, such as a natural language processor (NLP). For example, consider the shared resource as a vehicle. The NLP may extract information such as cost categories (e.g., fuel, maintenance, insurance), numerical values, and time periods (e.g., monthly, yearly). The NLP may use named entity recognition (NER) techniques to identify these relevant entities'relationships and values. The total costs may be considered the overall value of the shared resource. In various examples, the extracted information may be verified by a user (e.g., by selecting a checkbox) on the shared resource user interface 122 before the overall value is stored with a shared resource data structure.

The shared resource user interface 122 may also include a portion for selecting network-enabled computing devices to be associated with the shared resource. For example, dropdown menus may be selected, including various motion sensors, proximity sensors, mobile wallets, etc.

The web application may be executed according to application logic 110. Application logic 110 may use the various elements of application server 102 to implement the web application. For example, application logic 110 may issue API calls to retrieve or store data from data store 116 and transmit it for display on client device 104. Similarly, data entered by a user into a UI component may be transmitted using API 114 back to the web server. Application logic 110 may use other elements (e.g., machine learning model 120, shared resource user interface 122, sensor communication interface 124, shared resource data store 126, token management component 128, etc.) of application server 102 to perform functionality associated with the web application as described further herein.

Data store 116 may store data that is used by application server 102. Data store 116 is depicted as a singular element but may be multiple data stores. The data store 116 may include several databases of varying model architectures such as, but not limited to, a relational database (e.g., SQL), a non-relational database (NoSQL), a flat-file database, an object model, a document details model, graph database, shared ledger (e.g., blockchain), or a file system hierarchy. Data store 116 may store data on one or more storage devices (e.g., a hard disk, random access memory (RAM), etc.). The storage devices may be in standalone arrays, part of one or more servers, and located in one or more geographic areas.

Data structures may be implemented in several ways depending on the programming language of an application or the database management system used by an application. For example, if C++ is used, the data structure may be implemented as a struct or class. In the context of a relational database, a data structure may be defined in a schema.

User accounts 118 may store information on users of application server 102. A user account may include credential information such as a username and hash of a password. A user may enter their username and plaintext password on a login page of application server 102 to view their user account information or interfaces presented by application server 102 in various examples.

A user account may also include authorization to access other services in which the user has an account. The authorizations may include a token (e.g., using OAuth) or login credentials that authorize application server 102 to retrieve data from the other services in a defined format, such as JavaScript Object Notation (JSON) or extensible markup language (XML) over an API. A reciprocal authorization may also be stored in the user account that authorizes the other services to access data stored in the user account. For example, a user account may store authorizations for trip-planning websites, calendar services, and financial institutions, allowing the application server 102 to integrate and retrieve data from these services.

A user account may also include the user's preferences, such as preferred payment methods, notification settings, language preferences, and other customizable options. For instance, a user may prefer to receive notifications via email rather than SMS or choose to use PayPal® as their primary payment method. These preferences are stored in the user's account and may be modified by the user.

A user account may also identify computing devices associated with the user. For example, users may register one or more phones, desktop computers, tablets, or laptops with application server 102. Registering may include authorizing application server 102 to retrieve data from these devices, such as location data, browser history, etc. Users may revoke access to such data anytime by updating their account. The data may be gathered via an application installed on a registered device, such as by downloading an application from an app store associated with their mobile phone platform.

In addition, user accounts 118 may also store historical data related to the user's interactions with the shared resource. This can include past contributions, usage patterns (as determined by network-enabled computing devices), and transaction history. This data may be used to provide insights and recommendations, such as suggesting equitable payment distributions based on past activities or predicting future expenses.

“Associated” in the context of linking a shared resource data structure to a user account (or other data linkages described herein) may be implemented differently depending on the underlying database system. For example, in a relational database management system (RDBMS), “associated” may refer to the relationship between tables. The relationship could be one-to-one, one-to-many, or many-to-many, established through foreign key constraints. For example, in a one-to-many relationship, a record in Table A (e.g., the user accounts table) may be associated with multiple records in Table B (e.g., a shared resource data structures table), using a foreign key in Table B that references the primary key in Table A.

The token management component 128 may manage payments to and from users. For example, the token management component 128 may generate (or interact with existing) mobile wallet elements that users may use to pay for expenses related to the shared resource. For instance, when a group of friends plans a vacation, each participant may receive a mobile wallet payment element that may be used for various expenses during the trip. These mobile wallet elements are dynamically generated and linked to the shared resource, allowing users to make payments directly from their mobile devices.

The token management component 128 may also interact with users'preferred payment methods. For example, users may prefer different payment platforms like PayPal®, Venmo®, Zelle®, or other financial services. User accounts 118 may store details such as the user's preferred payment platform, account credentials, and authorization tokens.

When funds are required for the shared resource, the token management component 128 requests money from the users'preferred sources. For example, if a shared resource needs additional funding, the token management component 128 may automatically initiate a request to each user's preferred payment platform to transfer the required amount. The token management component 128 uses secure APIs these payment platforms provide to initiate and manage transactions.

Conversely, when money needs to be transferred to a user, the token management component 128 disburses the funds using the recipient's preferred payment method. For instance, if a user is owed reimbursement for expenses related to the shared resource, token management component 128 may automatically transfer the funds to the user's preferred payment platform.

FIG. 2 is a block diagram of a data structure 200, according to various examples. This data structure is designed to organize information related to shared resources. The data structure 200 may be a shared resource data structure stored in the shared resource data store 126. The data structure 200 may have a unique shared resource identifier 238.

The data structure 200 includes a shared resource type 202, which may be further classified into types of an asset 204, an association 206, or an event 208. The asset 204 type may represent tangible (e.g., a boat, rental property, etc.) or intangible (e.g., a service) items that users may share. The association 206 type may refer to a group or organization formed for a specific purpose (e.g., a homeowner's association). An event 208 type may be used for a specific occurrence or activity that involves shared participation, such as a vacation.

User identifiers 210 are the identifiers of users associated with the shared resource. A user identifier may be an email address or username and may correspond to a user identifier in user accounts 118. The user identifier 212 is associated with several attributes, including an apportionment value 214, user preferences 216, and activity 218. The apportionment value 214 indicates the user's share or contribution within the shared resource. User preferences 216 store individual user settings or choices related to the shared resource (e.g., as discussed in the context of user accounts 118).

Activity 218 may be stored as a set of entries in a data store (e.g., data store 116 of FIG. 1) containing information about events or actions related to the shared resource. An entry in the activity 218 data set may include a device identifier corresponding to one of the device identifiers in the network-enabled computing devices 230. The device identifier enables the system to associate the activity with a specific sensor or smart device, facilitating accurate tracking and attribution of actions. An entry may also include a timestamp indicating when the activity occurred.

Furthermore, an activity entry may include a data value that includes information or measurements captured by the device. The nature and format of the data value may vary depending on the type of device and the activity being recorded. The data value may be formatted in JavaScript Object Notation (JSON). For instance, an entry related to a motion sensor might include the device identifier of the specific motion sensor, a start timestamp indicating when motion was detected, an end timestamp showing when motion ceased, and a value representing the duration or intensity of the motion. Similarly, an entry for a smart lock sensor may contain the device identifier of the smart lock, a timestamp indicating when the lock was activated, and a data value representing the lock's state, such as locked or unlocked.

Activity 218 may be for a financial transaction using a mobile wallet token issued by token management component 128. For example, an entry could include a device identifier corresponding to the mobile device used for the payment, such as “MD007” for a specific smartphone. A timestamp may indicate when the payment was made, for instance, “2024-09-16T20:15:37Z”. The data value field may contain detailed information about the transaction, including the amount paid, the merchant, and the specific token used from the mobile wallet. For example, the data value might be structured as: {“transactionType”: “payment”, “amount”: 75.50, “currency”: “USD”, “merchant”: “Local Restaurant”, “tokenIdentifier”: “T12345”, “paymentPlatform”: “MobileWallet”}.

The apportionment value 214 relates to the overall value 220 of the data structure 200. An apportionment value is specifically associated with a user identifier 212 within a data structure, representing the individual user's share or contribution to the shared resource. In contrast, the overall value 220 represents the shared resource's total value or aggregate measure.

The relationship between these two values helps equitable management of the shared resource. For instance, in a shared asset scenario, such as the co-ownership of a boat, the apportionment value 214 might represent each user's financial investment or usage rights. In contrast, the overall value 220 would reflect the total worth of the boat. Thus, if a user has a 30% share in the boat, their apportionment value would reflect this 30% ownership. The apportionment value entitles the user to 30% of the boat's usage and benefits and 30% of the associated costs and responsibilities. Similarly, in an event context like a group vacation, the apportionment value 214 could represent each participant's contribution to the shared expenses, with the overall value 220 indicating the total budget for the trip.

However, the apportionment value 214 is not static and may be adjusted based on actual usage and contributions. If users use the boat more than their initial 30% share (e.g., based on activity 218), their apportionment value 214 would increase to reflect this additional usage. This dynamic adjustment ensures that the apportionment value 214 accurately represents each user's actual share of the asset over time. Consequently, if the user utilizes the boat 40% of the time, their apportionment value 214 would be updated to 40%, thereby increasing their share of the overall value 220.

When expenses are incurred for the shared resource, such as maintenance costs or operational expenses, the apportionment value 214 may be used to determine each user's financial responsibility. The overall value 220 serves as the basis for these calculations, ensuring that costs are equitably distributed among the users. For example, if the boat requires $1,000 in maintenance, a user with a 40% apportionment value 214 would be responsible for $400 of the total expense.

The shared resource configuration 222 encompasses several parameters that define the operational aspects of the shared resource. These parameters include but are not limited to, a voting value threshold 224, dates 226, and a dissolution process 228. The voting value threshold 224 sets the criteria for decision-making processes within the shared resource. For example, the voting value threshold 224 rule may store a dollar value above which users are not authorized to spend without a vote. Dates 226 tracks the operational times of an event-based shared resource (e.g., every 2nd week in January) or other dates related to the shared resource, such as creation, modification, or expiration dates. The dissolution process 228 outlines the steps or conditions for terminating the shared resource. For example, the dissolution process 228 may define that the sale proceeds of a shared resource are distributed according to the apportionment values of the user identifiers for the shared resource.

Entries for the network-enabled computing devices 230 may also be part of the data structure 200. Each network-enabled computing device 230 is identified by a device identifier 232, a device type 234, and a location 236. The device identifier 232 may uniquely identify each device. The device type 234 categorizes the kind of device, such as a sensor, camera, point-of-sale terminal, or other IoT devices. The location 236 specifies the geographical position or context of the device, which may be used for location-based tracking and matching.

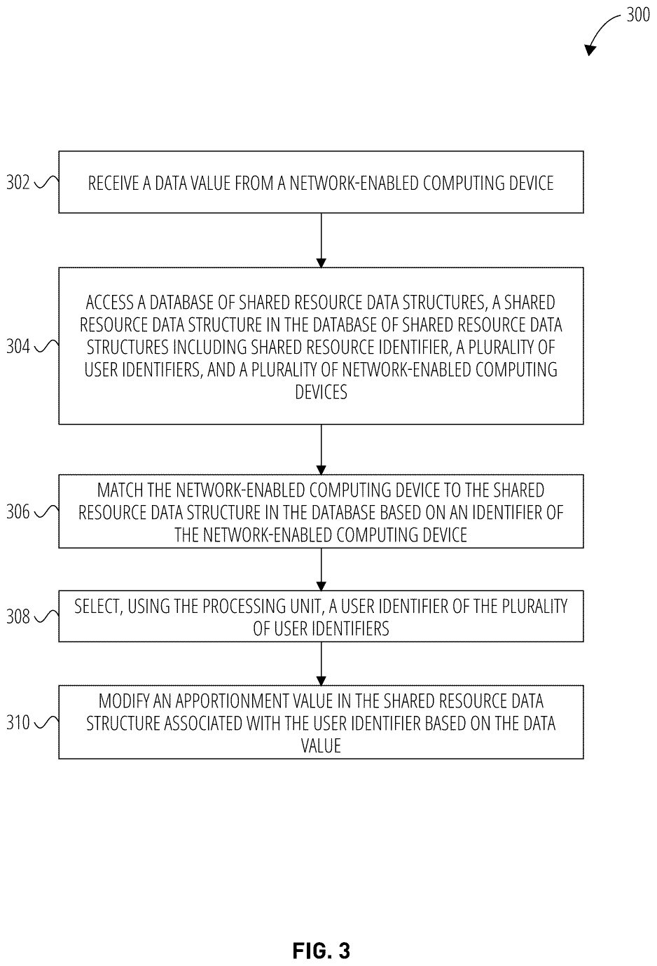

FIG. 3 is a flowchart illustrating a method 300 to modify a data structure based on a received data value, according to various examples. The method is represented as a set of blocks that describe operation 302 to operation 310. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which executes the set of instructions, may configure the processing unit to perform the operations illustrated in FIG. 3. The processing unit may instruct another component of a computing device to carry out the set of instructions. For example, the processing unit may instruct a network device to transmit data to another computing device, or the computing device may provide data over a display interface to present a user interface. In some examples, the method's performance may be split across multiple computing devices using a shared computing infrastructure (e.g., the processing unit encompasses multiple distributed computing devices).

At operation 302, the method may include receiving a data value from a network-enabled computing device. In various examples, the data value is received over an API at a server, such as using API 114 at application server 102. The data value may be encoded as a parameter of a payload of an API call in JSON format. The API call may also include an identifier of the network-enabled computing device. The data value may be received in response to communicating with a third-party service that manages the network-enabled computing device.

At operation 304, the method may include accessing a database of shared resource data structures, a shared resource data structure in the database of shared resource data structures including a shared resource identifier, a plurality of user identifiers, and a plurality of network-enabled computing device identifiers. In various examples, the network-enabled computing device may be a motion sensor or optical sensor. The database may be shared resource data store 126 of FIG. 1, in various examples. A shared resource data structure may be formatted as discussed in FIG. 2. The accessing may be in response to the receiving of operation 302.

In various examples, the method may further include presenting a shared resource data structure creation user interface. The interface may include a user participant portion configured to receive user identifiers for the plurality of user identifiers; a network-enabled computing device portion configured to receive identifiers for the plurality of the network-enabled computing devices; and a type of shared resource portion configured to receive a type of a shared resource associated with the shared resource data structure. The interface may be one as discussed for shared resource user interface 122 of FIG. 1. The user interface may be presented on a client device with a web browser.

The method may further include generating an input prompt based on a template and data in the shared resource data structure. The input prompt may be submitted to a generative artificial intelligence (GenAI) model. The method may include parsing the response from the GenAI model. Based on the response, the shared resource data structure may be updated with an overall value and apportionment values for each user identifier in the plurality of user identifiers. The process of generating the input prompt and parsing may be performed as described for shared resource user interface 122 of FIG. 1. For example, if the GenAI model outputs an expected cost of $12,000 and there are three user identifiers entered into the shared resource data structure creation user interface, each apportionment value may be $4,000 or 33.3% (assuming an equal distribution).

At operation 306, the method may include matching the network-enabled computing device to the shared resource data structure in the database based on an identifier of the network-enabled computing device. For example, a database query using the identifier may be executed to match the shared resource data structure.

At operation 308, the method may include selecting a user identifier of the plurality of user identifiers. The user identifier may be selected based on the type of network-enabled computing device.

In various examples, the selection may include when the network-enabled computing device is a motion sensor, accessing location data of a user computing device, the user computing device associated with the user identifier, and comparing the location data of the user computing device to the location data of the proximity sensor. The location data of the computing devices associated with the user identifiers in the matched shared resource data structure may be accessed using an application installed on the computing devices authorized to access the location data. The location data may be precise coordinates or a radius (e.g., within 10 meters). If the location data of a computing device is within a threshold distance (e.g., 20 feet) of the previously stored location of the proximity sensor, the user identifier associated with the computing device may be the selected user identifier.

In various examples, the selection may include when the network-enabled computing device is an optical device, executing a facial recognition model using the data value, and selecting the user identifier based on an output of the facial recognition model. The data value may be a still image or video data captured by the optical device. The facial recognition model may use the users'prior stored and authorized facial data points associated with the shared resource data structure. Suppose the probability of a match by the facial recognition model exceeds a certain threshold (e.g., 95%). In that case, it may be considered a match, and the user identifier may be the one selected at operation 308.

At operation 310, the method may include modifying an apportionment value in the shared resource data structure associated with the user identifier based on the data value. An apportionment value may be modified for the overall value 220 and apportionment value 214 of FIG. 2. For example, if the data value indicates a user identifier has been using the shared resource more than their apportionment value, the apportionment value may be increased. In various examples, apportionment values may be modified on a schedule (e.g., weekly, as opposed to each time a data value is received). In this manner, the apportionment values may reflect a week's use. A weighted formula may be stored that includes parameters such as number of times a user used the shared asset, expenses incurred for the asset, etc., to calculate a particular apportionment value. The values of the parameters may be based on the data values received from the network-enabled computing devices.

The method may further include generating a usage report for the shared asset. A usage report may include the activity of the shared resource based on the data values for the network-enabled computing devices associated with the shared resource. For example, the usage report may include an entry that indicates a user identifier unlocked the door to a shared resource six times last week. The usage report may be transmitted to computing devices associated with the user identifiers.

In various examples, the method may include, before modifying the apportionment value, determining that the data value exceeds a threshold value stored in the shared resource data structure. For example, the data value may be the cost of a potential purchase for the shared resource. In response to the determination, the method may include transmitting a request to the plurality of user computing devices associated with the shared resource data structure and determining that the number of positive responses to the request exceeds the number of negative responses. In various examples, the number of positive responses needed may be stored as part of a configuration (e.g., shared resource configuration 222).

The transmitting may occur using a push notification or text message. In various examples, the responses may be received using text or mobile apps. For example, a message may state, “User XYZ is requesting authorization for a purchase for ABC that costs $100 for your shared resource. Please reply YES or NO to authorize.”

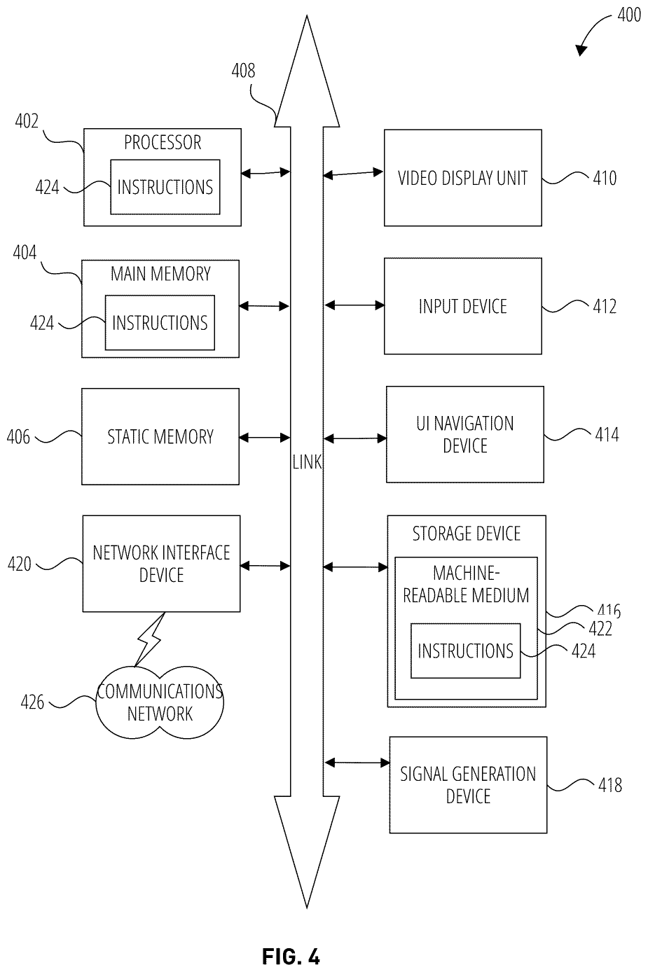

FIG. 4 is a block diagram illustrating a machine in the example form of computer system 400, within which a set or sequence of instructions may be executed to cause the machine to perform any of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) Network environments. The machine may be an onboard vehicle system, wearable device, personal computer (PC), tablet PC, hybrid tablet, personal digital assistant (PDA), mobile telephone, or any machine capable of executing instructions (sequential or otherwise) that specify actions to be taken by that machine. Further, while only a single machine is illustrated, the term “machine” includes any collection of machines that individually or jointly execute a set (or multiple sets) of instructions to perform any of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 400 includes at least one processor 402 (e.g., a central processing unit (CPU), a graphics processing unit (GPU) or both, processor cores, compute nodes, etc.), a main memory 404, and a static memory 406, which communicate with each other via a link 408. The computer system 400 may include a video display unit 410, an input device 412 (e.g., a keyboard), and a user interface UI navigation device 414 (e.g., a mouse). In an example, the video display unit 410, input device 412, and UI navigation device 414 are incorporated into a single device housing, such as a touchscreen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensors.

The storage device 416 includes a machine-readable medium 422 on which one or more sets of data structures and instructions 424 (e.g., software) embodying or utilized by any of the methodologies or functions described herein. The instructions 424 may also reside, completely or at least partially, within the main memory 404, the static memory 406, or within the processor 402 during execution thereof by the computer system 400, with the main memory 404, the static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database or associated caches and servers) that store the instructions 424. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” includes, but is not limited to, solid-state memories and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 422 that excludes transitory signals.

The instructions 424 may be transmitted or received over a communications network 426 using a transmission medium via the network interface device 420 utilizing a transfer protocol (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine and includes digital or analog communications signals or other intangible mediums to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
accessing a database of shared resource data structures, a shared resource data structure in the database of shared resource data structures including:
a shared resource identifier;
a plurality of user identifiers; and
a plurality of network-enabled computing device identifiers;
receiving, using a processing unit, a data value from a network-enabled computing device;
matching the network-enabled computing device to the shared resource data structure in the database based on an identifier of the network-enabled computing device;
selecting, using the processing unit, a user identifier of the plurality of user identifiers; and
modifying an apportionment value in the shared resource data structure associated with the user identifier based on the data value.

2. The method of claim 1, wherein the network-enabled computing device is a motion sensor.

3. The method of claim 2, wherein selecting the user identifier of the plurality of user identifiers includes:
accessing location data of a user computing device, the user computing device associated with the user identifier; and
comparing the location data of the user computing device to location data of the motion sensor.

4. The method of claim 1, wherein the network-enabled computing device is an optical sensor.

5. The method of claim 4, wherein selecting the user identifier of the plurality of user identifiers includes:
executing a facial recognition model using the data value; and
selecting the user identifier based on an output of the facial recognition model.

6. The method of claim 1, further comprising:
presenting a shared resource data structure creation user interface, the user interface including:
a user participant portion configured to receive user identifiers for the plurality of user identifiers;
a network-enabled computing device portion configured to receive identifiers for the plurality of the network-enabled computing devices; and
a type of shared resource portion configured to receive a type of a shared resource associated with the shared resource data structure.

7. The method of claim 6, further comprising:
generating an input prompt based on a template and data in the shared resource data structure;
submitting the input prompt to a generative artificial intelligence (GenAI) model;
receiving a response from the GenAI model;
parsing the response; and
based on the response, updating the shared resource data structure with an overall value and apportionment values for each of the user identifiers in the plurality of user identifiers.

8. The method of claim 1, further comprising, prior to modifying the apportionment value:
determining that the data value exceeds a threshold value stored in the shared resource data structure;
in response to the determining, transmitting a request to the plurality of user computing devices associated with the shared resource data structure; and
determining that a number of positive responses to the request exceeds a number of negative responses to the response.

9. A non-transitory computer-readable medium comprising instructions, which when executed by a processing unit, configure the processing unit to perform operations comprising:
accessing a database of shared resource data structures, a shared resource data structure in the database of shared resource data structures including:
a shared resource identifier;
a plurality of user identifiers; and
a plurality of network-enabled computing device identifiers;
receiving, using a processing unit, a data value from a network-enabled computing device;
matching the network-enabled computing device to the shared resource data structure in the database based on an identifier of the network-enabled computing device;
selecting, using the processing unit, a user identifier of the plurality of user identifiers; and
modifying an apportionment value in the shared resource data structure associated with the user identifier based on the data value.

10. The non-transitory computer-readable medium of claim 9, wherein the network-enabled computing device is a motion sensor.

11. The non-transitory computer-readable medium of claim 10, wherein selecting the user identifier of the plurality of user identifiers includes:
accessing location data of a user computing device, the user computing device associated with the user identifier; and
comparing the location data of the user computing device to location data of the motion sensor.

12. The non-transitory computer-readable medium of claim 9, wherein the network-enabled computing device is an optical sensor.

13. The non-transitory computer-readable medium of claim 12, wherein selecting the user identifier of the plurality of user identifiers includes:
executing a facial recognition model using the data value; and
selecting the user identifier based on an output of the facial recognition model.

14. The non-transitory computer-readable medium of claim 9, wherein the instructions, which when executed by the processing unit, further configure the processing unit to perform operations comprising:
presenting a shared resource data structure creation user interface, the user interface including:
a user participant portion configured to receive user identifiers for the plurality of user identifiers;
a network-enabled computing device portion configured to receive identifiers for the plurality of the network-enabled computing devices; and
a type of shared resource portion configured to receive a type of a shared resource associated with the shared resource data structure.

15. The non-transitory computer-readable medium of claim 14, wherein the instructions, which when executed by the processing unit, further configure the processing unit to perform operations comprising:
generating an input prompt based on a template and data in the shared resource data structure;
submitting the input prompt to a generative artificial intelligence (GenAI) model;
receiving a response from the GenAI model;
parsing the response; and
based on the response, updating the shared resource data structure with an overall value and apportionment values for each of the user identifiers in the plurality of user identifiers.

16. The non-transitory computer-readable medium of claim 9, wherein the instructions, which when executed by the processing unit, further configure the processing unit to perform operations comprising, prior to modifying the apportionment value:
determining that the data value exceeds a threshold value stored in the shared resource data structure;
in response to the determining, transmitting a request to the plurality of user computing devices associated with the shared resource data structure; and
determining that a number of positive responses to the request exceeds a number of negative responses to the response.

17. A system comprising:
a processing unit; and
a storage device comprising instructions, which when executed by the processing unit, configure the processing unit to perform operations comprising:
accessing a database of shared resource data structures, a shared resource data structure in the database of shared resource data structures including:
a shared resource identifier;
a plurality of user identifiers; and
a plurality of network-enabled computing device identifiers;
receiving, using a processing unit, a data value from a network-enabled computing device;
matching the network-enabled computing device to the shared resource data structure in the database based on an identifier of the network-enabled computing device;
selecting, using the processing unit, a user identifier of the plurality of user identifiers; and
modifying an apportionment value in the shared resource data structure associated with the user identifier based on the data value.

18. The system of claim 17, wherein the network-enabled computing device is a motion sensor.

19. The system of claim 18, wherein selecting the user identifier of the plurality of user identifiers includes:
accessing location data of a user computing device, the user computing device associated with the user identifier; and
comparing the location data of the user computing device to location data of the motion sensor.

20. The system of claim 17, wherein the network-enabled computing device is an optical sensor.
